(19) United States
(12) Patent Application Publication
(10) Pub. No.: US 2006/0118399 A1
(43) Pub. Date: Jun. 8, 2006

(54) Sub-miniature switch

(76) Inventors: Thomas Schober, Iber (DE); Stefan Reindl, Auerbach (DE)

Correspondence Address: JORDAN AND HAMBURG LLP, 122 EAST 42ND STREET, SUITE 4000, NEW YORK, NY, 10168, US

(21) Appl. No.: 11/262,096

(22) Filed: Oct. 28, 2005

(30) Foreign Application Priority Data
Oct. 28, 2004 (DE) 10 2004 052 413.0

(51) Int. Cl. H01H 5/00

(52) U.S. Cl. 200/402

(57) ABSTRACT

The invention relates to a sub-miniature switch including a housing, an actuator and terminals. The actuator protrudes from the housing at a position offset from the center of the housing. The terminals are electrically conductively coupled with fixed contacts (positioned within the housing). A contact maker is moved via the actuator and held in a first or second switching position by means of a bistable spring arrangement. An additional component, a separator or auxiliary actuator, is in snap-fit engagement with or clamped or glued in the cover of the housing and is pushed through by the actuator as the switch is operated. According to the present invention, the contact point of the fixed contacts is on a side of the housing which is opposite the actuator. The separator or auxiliary actuator is moved in the direction of the contact position by the actuator. Thus a structurally simple forced-opening capability is provided for the sub-miniature switch.

### BACKGROUND OF THE INVENTION

The present invention relates to a sub-miniature switch of a type which is known in the state of the art, in particular from EP 618 603 B1 and GB 2 142 471 A.

The sub-miniature switches according to the prior art have a housing with a cover, an actuator protruding from the housing, and external terminals. The actuator is offset from the center of the housing. The terminals are connected in an electrically conducting way with fixed contacts positioned inside the housing. A moveably supported, in particular rotatably supported, contact maker can take up two positions depending on the position of the actuator. In both the first and second switching positions, the contact maker is held by a bistable spring arrangement (tension spring).

An additional component, a hold-down plate or separator or auxiliary actuator is provided in the housing, which is pushed through by the actuator as it is switched over from the first switching position to the second switching position. In the prior art, the auxiliary actuator is supported at the actuator.

Such sub-miniature switches are used in the industrial field in tube motors of roller blind drives or roller sun visor drives in order to sense the end-of-travel positions of the roller blind or sun visor. Stringent requirements are put on these micro-switches with respect to their operating safety and service life. The capacitive loads on the contacts in the end-of-travel positions easily lead to sticking or fusing of the contacts. The normal contact release force exerted by the tension spring of the bistable spring arrangement no longer suffices to pull away the stuck contact. This can lead to the destruction of the drive as it is not switched off. In order to avoid this it has to be ensured that the contact to be opened is mechanically opened after a defined travel distance of the actuator despite sticking of the contacts.

For this purpose, additional separators are known. Due to the addition of a component, the manufacture and assembly of these micro-switches is made more complex.

It is an object of the present invention to provide a sub-miniature switch of the type initially mentioned with a structurally simple and reliable forced-opening capability without increasing the structural size.

### SUMMARY OF THE INVENTION

The approach according to the present invention is characterized in that the separator or auxiliary actuator is fixed in a cover of the housing and in that the separator or auxiliary actuator is moved by the actuator precisely in the direction of the contact point. As a rule, the separator is snapped into engagement with the cover of the housing. However, the separator can also be clamped or glued to the cover. The cover is configured in such a way that it can absorb a deflection of the separator. A transverse strut at the level of the contacts is mounted between the supporting position in the cover and the application position of the actuator. When the separator is pushed down on the contact maker by the actuator, the transverse strut tears open any fusing of the so-called NC contact.

This approach is simpler than the known solutions of the prior art and enables a forced opening to be effected at this contact point in the case of a fusion of the so-called NC contact, wherein the separator directly contacts the contact maker and causes the fused contacts to tear open by the application of a force which is parallel to the direction of movement.

### BRIEF DESCRIPTION OF THE DRAWINGS

In the following, an exemplary embodiment of the present invention will be explained in more detail, in which:

FIG. 1 is a view of the sub-miniature switch including a separator and an actuator;

FIG. 2 is a sectional view of the micro-switch in the starting position of the actuator;

FIG. 3 is a view of the micro-switch with fused contacts, wherein the separator engages the contact maker; and

FIG. 4 is a sectional view of the micro-switch in the end position of the actuator.

### DETAILED DESCRIPTION OF THE INVENTION

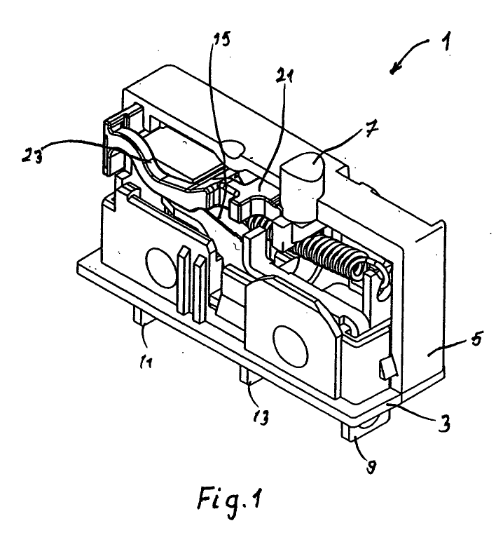

In the perspective view according to FIG. 1, the sub-miniature switch 1 can be seen with the actuator 7 at the top and the contact tabs or terminals 9, 11 and 13 at the bottom. The structure is supported on the base 3 of the housing from which the terminals 9, 11 and 13 protrude downwards. Only half of the cover 5 of the housing is shown.

In this type of micro-switch, the actuator 7 is not centrally positioned, but offset to the right (in the present example). Via a tension spring 19, the actuator 7 pushes on a contact maker 15, which is moveably (in particular pivotably) supported and has two contacts 17 at its moveable end. The blade of the contact maker 15 is electrically connected to a common terminal 9 via a contact support (not shown). The contacts 17 form contact points with fixed contacts 24 and 27. The top fixed contact 24 is electrically connected to the terminal 11 via a connecting conductor 25; the bottom fixed contact 27 is correspondingly connected to the terminal 13.

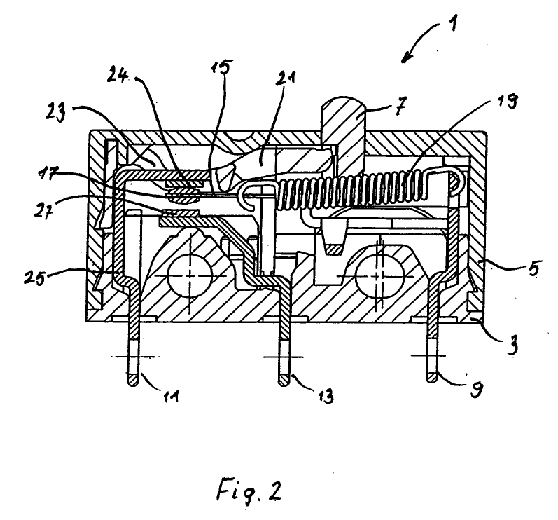

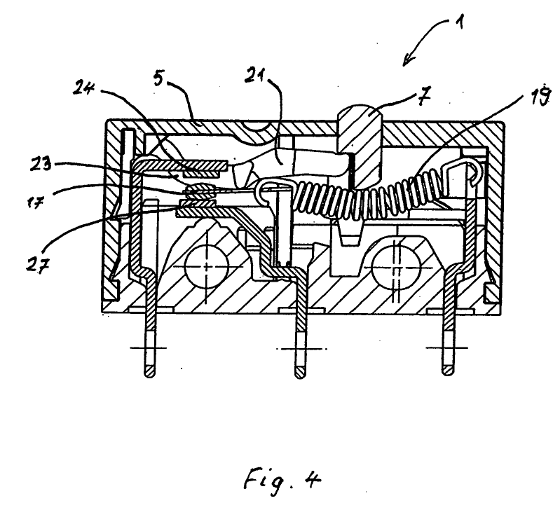

In the sectional view of FIG. 2, the actuator 7 is shown in its starting position. The tension spring 19 and the contact maker 15 are configured as a bistable spring arrangement and stabilize the contact maker 15 initially in a top contacting position (initial position of the actuator 7 in FIG. 2) and stabilize the contact maker 15, according to FIG. 4, in a bottom contacting position (end-of-travel position of the actuator 7).

As initially described, the contact maker 15 in the contact position shown in FIG. 2 tends to fuse with or stick to the fixed contact 24. By an additional component, the separator or auxiliary actuator 21, the terminal 11 (NC contact) is mechanically assisted when the contact is opened. Upon operation, the actuator 7 also engages the auxiliary actuator 21. The separator 21 then presses on the contact maker 15 in the area of the fixed contacts 24, 27 via a transverse strut 23 in order to tear away the contact maker 15. As shown in FIG. 1, the auxiliary actuator 21 is fixed to the housing cover 5 at its left-hand side. On its right-hand side the separator 21 is moveable and can assist in opening the mechanical contact by means of its transverse strut 23.

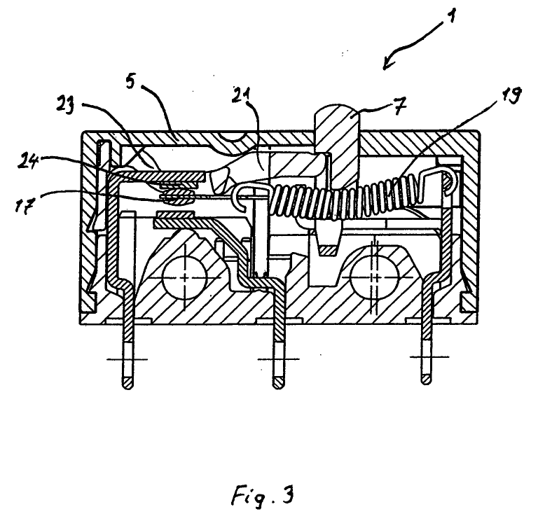

FIG. 3 shows an intermediate situation in which the actuator has not yet reached its end position according to FIG. 4. But the tension spring 9 has already started releasing the contact. FIG. 3 shows the phase in which the transverse strut 23 of the separator 21 comes into assisting engagement.

### LIST OF REFERENCE NUMERALS

1 sub-miniature switch or micro-switch
3 housing base
5 housing cover
7 actuator
9 common terminal COM
11 NC terminal
13 NO terminal
15 moveably supported contact maker
17 contacts of contact maker 15
19 tension spring of a bistable spring arrangement
21 separator or auxiliary actuator
23 transverse strut of separator 21
24 fixed contact of terminal 11
25 connection line from terminal 11 to fixed contact 24
27 fixed contact of terminal 13

1.-4. (canceled)

5. A sub-miniature switch, comprising
a housing comprising a cover;
a first actuator offset with respect to a center of the housing and protruding therefrom;
contacts fixed within the housing, the fixed contacts being arranged on a side of the housing opposite the actuator;
terminals electrically conductively connected to the fixed contacts;
a contact maker moveably supporting contacts;
a bistably arranged spring for holding the contact maker in a first switching position in which one of the moveably supported contacts is in contact with one of the fixed contacts or in a second switching position, depending on a corresponding switching position of the first actuator; and
a separator fixed in the cover of the housing, the first actuator engaging the separator to effect engagement of the separator with the contact maker to move the contact maker so that one of the moveably supported contacts is moved from a position in contact with one of the fixed contacts to a position out of the contact with one of the fixed contacts, the separator thereby functioning as an auxiliary actuator.

6. The sub-miniature switch according to claim 5, wherein the separator includes an end which is free to move and the separator further comprises a strut a portion of which in a lengthwise direction of the strut is spaced transversely from other portions of the separator, the engagement of the separator with the contact maker occurring by engagement of an area on the strut with an area on the contact maker adjacent the moveably supported contacts.

7. The sub-miniature switch according to claim 5 or 6, wherein the separator is in snap-fit engagement in the cover.

8. The sub-miniature switch according to claim 5 or 6, wherein the separator is clamped in the cover.

9. The sub-miniature switch according to claim 5 or 6, wherein the separator is glued in the cover.
